(19) United States
(12) Patent Application Publication
(10) Pub. No.: US 2013/0046710 A1
(43) Pub. Date: Feb. 21, 2013

(54) METHODS AND SYSTEM FOR FINANCIAL INSTRUMENT CLASSIFICATION

(71) Applicants: URI KARTOUN, Washington, DC (US); DAVID KARTOUN, Ramat-Hasharon (IL)

(72) Inventors: URI KARTOUN, Washington, DC (US); DAVID KARTOUN, Ramat-Hasharon (IL)

(73) Assignee: STOCKATO LLC, Washington, DC (US)

(21) Appl. No.: 13/567,111

(22) Filed: Aug. 6, 2012

Related U.S. Application Data
(60) Provisional application No. 61/523,851, filed on Aug. 16, 2011.

(51) Int. Cl. G06Q 40/06

(52) U.S. Cl. 705/36 R

(57) ABSTRACT

The invention relates generally to financial instrument classification and more particularly to methods and system for recognizing similarities in behaviors among financial instruments. According to one embodiment, a method of classifying similar financial instruments is provided. Classification analysis is performed on a desired financial instrument that a user specifies to determine other financial instruments that behave similarly to the specified financial instrument during a specified time range. Based on the classification, the similarly behaving financial instruments and additional characteristics are presented to the user for evaluation and tracking.

### FIELD OF INVENTION

The present invention relates to financial instrument classification and more particularly, the present invention relates to financial instrument classification that is able to classify different financial instruments based on similarities in behavior patterns.

### 1. BACKGROUND AND PRIOR ART

Classification methods for financial instruments such as mutual funds, exchange-traded funds, stocks, and bonds, are commonly used to identify investments that meet one's personal criteria. Such methods aim to save time by narrowing one's search from hundreds of thousands of the worldly available investment choices down to a manageable number of specific investments for further research and examination. These classification methods (e.g., financial instrument screeners) facilitate a user to create a list of specific financial instruments he or she desires to further compare and analyze. This is achieved by letting the user specify comparison criteria applied to the list of financial instruments he or she is considering. Criteria include parameters such as performance history, investment style and category, and fees, to name a few.

One disadvantage of current financial instrument classification systems is the lack of ability to classify different financial instruments based on similarities in behavior patterns. An example of a behavior pattern would be a time series of a financial instrument considered in a specific time period, wherein the time series is a sequence of data points that represent the daily change in the financial instrument price. The level of similarity between two financial instruments is determined by calculating a Similarity Rank value and described in more detail in the Detailed Description section. Another disadvantage of current financial instrument classification systems is that they require the user to be financially knowledgeable enough to create a list of financial instruments of interest and to have the ability to pick the appropriate criteria. Another disadvantage is the inability to classify financial instruments from different classes, for example, to find behavioral similarities between a certain stock and a certain mutual fund or between a certain exchange-traded fund and a certain bond. Another disadvantage is the inability to classify financial instruments from different stock exchanges and/or from different countries, for example, to find behavioral similarities between a certain Israeli mutual fund and a certain American exchange-traded fund.

### 2. SUMMARY

One embodiment of the financial instrument classification methods and system described herein facilitates a user to specify a financial instrument and one or more screening criteria such as a time range, and receive financial instruments that behave similarly to it.

In another embodiment, the historical and current prices of the financial instruments considered are plotted as a graph in a user interface display, for example, as price vs. time. This facilitates further comparison and analysis of the behavior of the financial instruments.

In another embodiment, the methods employ machine learning algorithms to classify the behavior of financial instruments based on the price performance of financial instruments, i.e., the daily prices of financial instruments and the change in the daily prices.

In another embodiment, the prices of the financial instruments considered for classification are adjusted and take into account benefits, such as the impact of dividends for stocks and interest rates for bonds.

In another embodiment, classification is based on the returns of the financial instruments. The return is defined as the gain or loss of a financial instrument in a particular period and consists of the income and the capital gains of an investment. The return is quoted as a percentage.

In another embodiment, the methods provide similarities between time series representing other information, not necessarily limited to prices or returns of financial instruments.

In another embodiment, the methods provide similarities between financial instruments as trading occurs, i.e., the user specifies a financial instrument, and he or she receives a list of financial instruments that behave similarly to the specified financial instrument during a pre-defined time period (e.g., one minute). The updated prices and additional characteristics such as description, sector and stock exchange of the specified financial instrument and those found to be similar to the financial instrument are plotted in a user interface display.

According to the teachings of the present invention, there is provided a classification method for selecting financial instruments, performed by a computer processor. The classification method includes the steps of: specifying a particular financial instrument, specifying one or more screening criteria, querying a database, coupled to operate with the computer processor, with the particular financial instrument and the screening criteria, and retrieving financial instruments from the database that behave similarly to the particular financial instrument and the screening criteria, to thereby obtain acquired financial instruments.

Optionally, one of the screening criteria is a time range determined by a starting time and an ending time.

Optionally, the similarity in behavior of the particular financial instrument is determined by calculating a ranking measure, wherein the higher is the ranking measure, between the particular financial instrument and one of the acquired financial instruments, the more similarly behaving the two financial instruments are.

Optionally, the acquired financial instruments are presented in a descending order, according to similarity rank results, while the most similar is presented first.

Optionally, the particular financial instrument and the acquired financial instruments include sets of time-dependent numbers that represent prices for the financial instruments, wherein the prices for a financial instrument, selected from the group consisting of the particular financial instrument and the acquired financial instruments, are adjusted to represent the effect of benefits provided by the financial instruments.

Optionally, the particular financial instrument includes a set of time-dependent numbers that represents prices for a market index, wherein the market index is an aggregated value obtained from a weighted sum of the acquired financial instruments and expressing the total values of the acquired financial instruments against a base value from a specific date.

Optionally, each of the acquired financial instruments is coupled with one or more indicators associated with the particular financial instrument and the screening criteria.

Optionally, the indicator is selected from a group of expressions including an expression that represents the difference in fees between the specified financial instrument and the acquired similarly behaving financial instrument, an expression that represents the difference in return between the specified financial instrument and the acquired similarly behaving financial instrument, and an expression that represents the difference in risk between the specified financial instrument and the acquired similarly behaving financial instrument.

Optionally, the classification method further includes the step of displaying the acquired financial instruments on a display unit coupled to operate with the computer processor.

Optionally, the acquired financial instruments are acquired from a remote database, over a data network.

Optionally, each of the financial instruments includes a set of derived time-dependent numbers that represent returns for each of the respective financial instrument.

Optionally, the particular financial instrument and/or the acquired financial instruments are abbreviations used to uniquely identify publicly traded financial instruments, or abbreviations used to uniquely identify custom generated time series representing hypothetical trading.

An aspect of the present invention is to provide a computer software product for interactively selecting financial instruments, the computer software product embodied in a non-transitory computer-readable medium in which program instructions are stored, wherein the program instructions, when read by a computer processor, perform a classification method that includes the steps of: selecting a financial instrument, specifying one or more screening criteria, querying a database, coupled to operate with the computer processor, with the selected financial instrument and the screening criteria, and retrieving matched financial instruments that behave similarly to the selected financial instrument and the screening criteria, from the database.

Optionally, the computer software product further includes the step of storing the matched financial instruments.

Optionally, in the computer software product, said screening criteria comprise a time range.

Optionally, the computer software product further includes the step of storing in the database additional behavioral descriptors for the specified financial instrument and for the matched financial instruments.

Optionally, the computer software product further includes the step of sending a financial instrument and additional criteria over a network between the computer processor and the database.

Optionally, the computer software product further includes a user interface that facilitates a user to specify a financial instrument and additional criteria, as well as to view similarly behaving financial instruments and additional behavioral descriptors.

According to further teachings of the present invention, there is provided a system for classifying financial instruments. The system includes a classifying server having a computer processor and a classifying database, at least one user computer terminal, including a display, and a public financial instruments database operatively connected to the classifying server.

The user computer facilitates a user to send a request to the classifying server and wherein the request includes a specific financial instrument and one or more screening criteria. The classifying server is facilitated to identify in the public financial instruments database financial instruments that behave similarly to the specific financial instrument according to the screening criteria; to calculate a similarity ranking measure between every two financial instruments to thereby create classification results; to store the classification results in the classifying database; and to send the classification results to the user computer.

An aspect of the present invention is to provide a method for grouping time series over a pre-defined time range, wherein a time series is a sequence of values. The method includes the steps of: splitting the time range into a collection of time slices, wherein for each time series in each of the time slices, the method performs the following steps: generating a modified time series including value differences between every two subsequent values of the time series, and calculating a numerical value representing the time series denoted as a label, wherein the numerical value is a summation of the values of the modified time series at the time slice considered.

The grouping method further includes the steps of: applying a classification algorithm on the time slice data points where the inputs for the algorithm are the modified time series and the respective calculated labels, thereby creating different groups of time series, wherein each group contains similarly behaving time series, and storing the groups of time series.

Optionally, the grouping method further including the steps of: finding similarities for a particular time series during a partial period of the pre-defined time range, applying a decision tree classification algorithm on each time slice, wherein each time slice is represented as a decision tree data structure, and for each decision tree data structure associated with a time slice at the partial time range, the grouping method performs the following steps: finding the nodes that contain the particular time series, for each node that contains the particular time series, finding other time series and increasing by one a counter value associated with each time series found, and sorting the time series in a descending order according to the total counter value, wherein the higher each of the counters is, the more similarly behaving the respective time series is, to the particular time series.

Optionally, in the grouping method, the time series includes a set of time-dependent numbers that represent prices for financial instruments.

Optionally, in the grouping method, each of the time series includes a set of derived time-dependent numbers that represent returns for financial instruments.

### 3. DESCRIPTION OF DRAWINGS

The specific features, aspects, and advantages of the disclosure will become better understood with regard to the following description, appended claims, and accompanying drawings where:

FIG. 1 is exemplary system architecture for employing one exemplary embodiment of the financial instrument classification methods and system described herein.

FIG. 2 depicts an exemplary flow diagram for employing one embodiment of the financial instrument classification methods and system described herein.

FIG. 3 depicts a user interface employed by one exemplary embodiment of the financial instrument classification methods and system described herein.

FIG. 4 depicts an exemplary flow diagram for employing one embodiment of the financial instrument classification methods and system described herein.

FIG. 5 is a partial representation of an exemplary decision tree for providing classification results in one embodiment of the financial instrument classification methods and system described herein.

FIG. 6 is an example for price time series representing several dozens of financial instruments.

FIG. 7 is an example for grouping of price time series representing several groups of financial instruments.

### 4. DETAILED DESCRIPTION

### 4.1 Preface

In the following detailed description, reference is made to the accompanying drawings that show, by way of illustration, specific embodiments in which the invention may be practiced. It is to be understood that other embodiments may be utilized and structural changes may be made without departing from the scope of the claimed subject matter.

In machine learning, classification refers to an algorithmic procedure for assigning a given piece of input data to one of a given number of categories. One example is assigning a candidate for a university program to “accepted” or “denied” admission classes or assigning a “diabetic” or “non-diabetic” medical diagnosis to a patient based on values of certain characteristics such as gender, age, vital signs, lab observations, etc.

An algorithm that implements classification is known as a “classifier.” The term classifier refers to the mathematical function implemented by a classification algorithm that maps input data to a category. The piece of input data is formally termed an “instance,” and the categories are termed “classes.” The instance is formally described by a vector of features, which together constitute a description of all known characteristics of the instance.

Classification normally refers to a supervised procedure, i.e., a procedure that classifies new instances based on learning from a data set of instances that have been properly labeled with the correct classes. The corresponding unsupervised procedure is known as clustering, which clustering involves grouping data into classes based on a measure of similarity, such as the distance between instances.

The following sections provide a background of financial instrument comparison in general, an overview of the proposed financial instrument classification methods and system, as well as an exemplary architecture. A layout for a user interface for one exemplary embodiment of the system is also provided. Lastly, a detailed description of the components and the features of the methods and system, as well as alternate embodiments, are provided.

Numerous investment institutions (e.g., Fidelity Investments, Vanguard, etc.), software companies (e.g., Google, Yahoo!, etc.), banks (e.g., Bank of America), and websites (e.g., Bloomberg.com, NASDAQ.com, etc.) offer Internet-based interactive research tools to facilitate users to evaluate and compare, i.e., to classify, a variety of financial instruments, such as mutual funds, exchange-traded funds, stocks, and bonds. Some background information on major financial instrument categories is provided in the paragraphs below.

A mutual fund is a type of investment that pools money from many investors in stocks, bonds, money-market instruments, other securities, or cash. Partial criteria for mutual funds include categories such as: 1) Fund Objective—each fund has a predetermined investment objective that tailors the fund's assets, regions of investments, and investment strategies. The fund's objectives are defined by factors, such as how steady its cash flow is, how risky it is, and how diversified its assets are; 2) Morningstar Rating—a rating system created by Morningstar, Inc., ranking mutual funds based on the risk-adjusted performance over various periods, ranging from one as the worst to five as the best; 3) Year-to-Date, 1-Year, 3-Year, 5-Year, and 10-Year Performance; 4) Expenses and Expense Ratios—associated fees such as management fees, non-management expenses, investor fees and expenses, brokerage commissions, etc.; and 5) Assets. Additional data may be provided with research tools for the specified financial instruments, for example, performance history, loads, redemption fees, etc.

The stock or capital stock of a business entity represents the original capital paid into or invested in the business by its founders. Partial criteria for stocks include categories such as: 1) Price Information—includes parameters such as market value and current last sale (CLS); 2) Trade Information—includes parameters such as volume, 50 average daily volume, and beta, defined as a measure of the volatility of a stock relative to the overall market; 3) Earnings; 4) Dividends, and; 5) Analyst Information—includes criteria such as forecast earnings growth, industry forecast earnings growth, and growth rate relative to industry.

A bond is a debt security in which the authorized issuer owes the holders a debt and, depending on the terms of the bond, is obliged to pay interest (the coupon) and/or repay the principal at a later date, which later date is termed maturity. A bond is a formal contract to repay borrowed money with interest at fixed intervals. Partial criteria for bonds include categories such as: 1) Nominal, Principal, or Face Amount—the amount on which the issuer pays interest, and which interest, most commonly, has to be repaid at the end of the term; 2) Issue Price—the price at which investors buy the bonds when they are first issued, which price will typically be approximately equal to the nominal amount. The net proceeds that the issuer receives are the issue price, minus issuance fees; 3) Maturity Date—the date on which the issuer has to repay the nominal amount. As long as all payments have been made, the issuer has no more obligations to the bondholders after the maturity date. The period of time until the maturity date is often referred to as the term, or maturity of a bond. The maturity can be any length of time, although debt securities with a term of less than one year are generally designated money-market instruments rather than bonds. Most bonds have a term of up to 30 years. Some bonds have been issued with maturities of up to 100 years, and some never mature; and 4) Coupon—the interest rate that the issuer pays to the bondholders.

An exchange-traded fund (ETF) is an investment fund traded on stock exchanges, much like stocks. An ETF holds assets such as stocks, commodities, or bonds, and trades at approximately the same price as the net asset value of its underlying assets over the course of the trading day. Most ETFs track an index, such as the S&P 500.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment,” “some embodiments” or “other embodiments” means that a particular feature, structure, or characteristic described in connection with the embodiments is included in at least one embodiment, but not necessarily all embodiments, of the inventions. It is understood that the phraseology and terminology employed herein are not to be construed as limiting and are for descriptive purpose only.

Methods of the present invention may be implemented by performing or completing manually, automatically, or a combination thereof, selected steps or tasks. The order of performing some methods' steps may vary. The descriptions, examples, methods and materials presented in the claims and the specification are not to be construed as limiting but rather as illustrative only.

Meanings of technical and scientific terms used herein are to be commonly understood as to which the invention belongs, unless otherwise defined. The present invention can be implemented in the testing or practice with methods and materials equivalent or similar to those described herein.

### 4.2 System Description

The following paragraphs provide an exemplary description for employing the financial instrument classification methods and system. It should be understood that in some cases, the order of actions can be interchanged, and in other ones, some of the actions may even be omitted.

In one embodiment of the financial instrument classification methods and system, the user (e.g., an investor) specifies a financial instrument and screening criteria such as a time range at a client computer which financial instrument and screening criteria are sent to a local or remote server computer. Additional screening criteria may include an objective such as “Municipal Bonds,” “Blend,” or “Diversified Emerging Markets.” Screening criteria may also include a specific stock exchange and/or a specific country in which stock exchange and/or country the financial instruments are traded at. Screening criteria may also include a specific type such as “Stocks,” “Mutual Funds,” or “Exchange-Traded Funds.” The server computer provides the user in real-time a list of financial instruments that behave similarly to the specified financial instrument during the specified time range. It should be noted that the list of financial instruments and additional details associated with them can be acquired either in real-time or not in real-time, wherein real-time, as used herein, is as quickly as the financial instrument and time range are typed, and non-real-time is a delayed display, and wherein delayed is referred to some later time. Additionally, it should be noted that the time range and/or the financial instrument could be default values determined in advance—in this case the user is not required to specify the time range and/or the financial instrument. An example for non-real-time interaction is having the user receiving delayed classification results attached to an email message. Email is considered as a communication method in which method electronic messages are sent between people, and received at some later time, not necessarily in real-time. Occasionally the length of time between sending and receiving a particular email is in the range of several seconds to several hours. Another scenario for non-real-time is when a user receives classification results periodically, for example, several hours after a pre-defined trading period was ended, daily-based, weekly-based, monthly-based, etc. In such cases there is no significant importance to the immediacy of receiving the classification results.

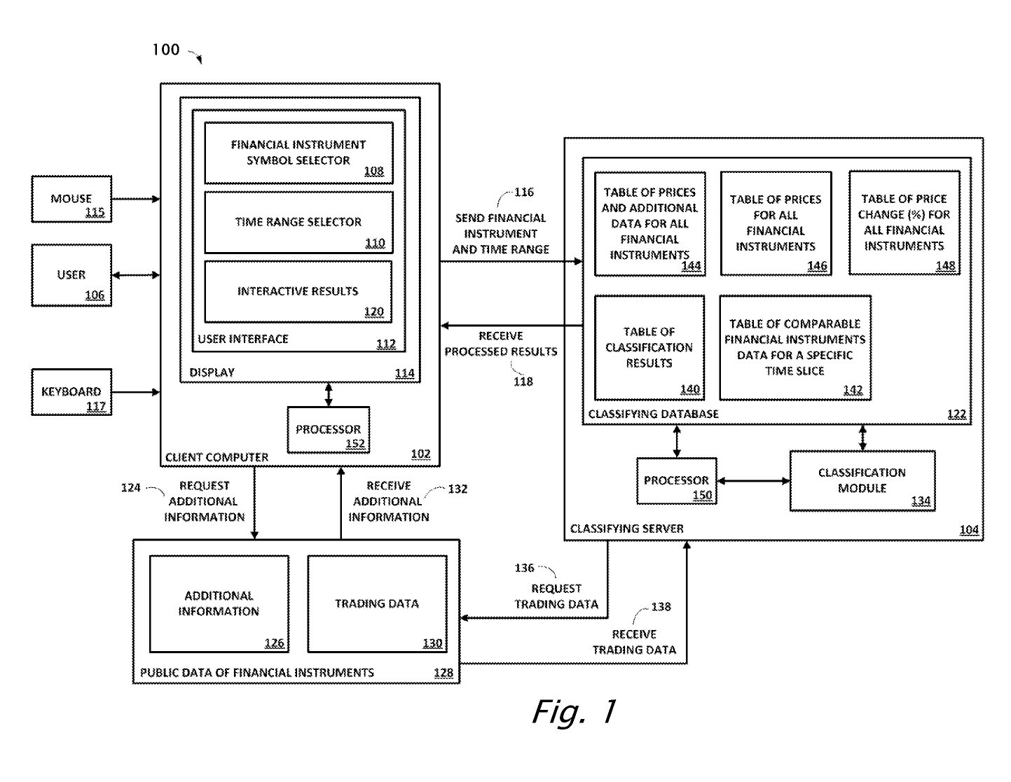

FIG. 1 provides an exemplary system architecture 100 for employing one embodiment of the financial instrument classification methods and system. As shown in FIG. 1, the system architecture 100 employs a client computer 102 and a classifying server 104. The client computer 102 facilitates a user 106 to specify a financial instrument 108 and a time range 110 via a user interface 112 presented, with no limitation, on a display 114, coupled to operate with client computer 102. The financial instrument 108 and the time range 110 specified by the user 106 are sent to a classifying database 122, operatively coupled with classifying server 104, preferably in a textual format. The classifying database 122 contains several tables including one or more data structures such as tables of classification results 140, and one or more data structures such as tables of comparable financial instrument data 142 and 148 (the structure and functionality of the tables are described with greater detail in Section 4.3). Once a user-request 116 is received by the classifying server 104, the classifying server 104 processes the user-request 116 and sends processed classification results 118 back to the client computer 102.

In response to receiving the processed classification results 118, including a list of financial instruments, the client computer 102 provides on the display 114 interactive results 120 that include a representation of the financial instruments, preferably hyperlinked textual representation, wherein the financial instruments behave most similarly to the financial instrument 108 during the time range 110 specified. The user 106 can act on these results and sort them. In addition, the client computer 102 may request 124 additional financial details 126 associated with the specified financial instrument 108 and the similarly behaving financial instruments, i.e., the processed classification results 118. Such additional financial details 126 are available at one or more public databases 128 and are provided by variety of resources such as NASDAQ or NYSE stock exchanges. The additional financial details 126 and trading data (such as prices and volumes) 130 associated with the financial instruments are received 132 by the client computer 102 and presented on the display 114.

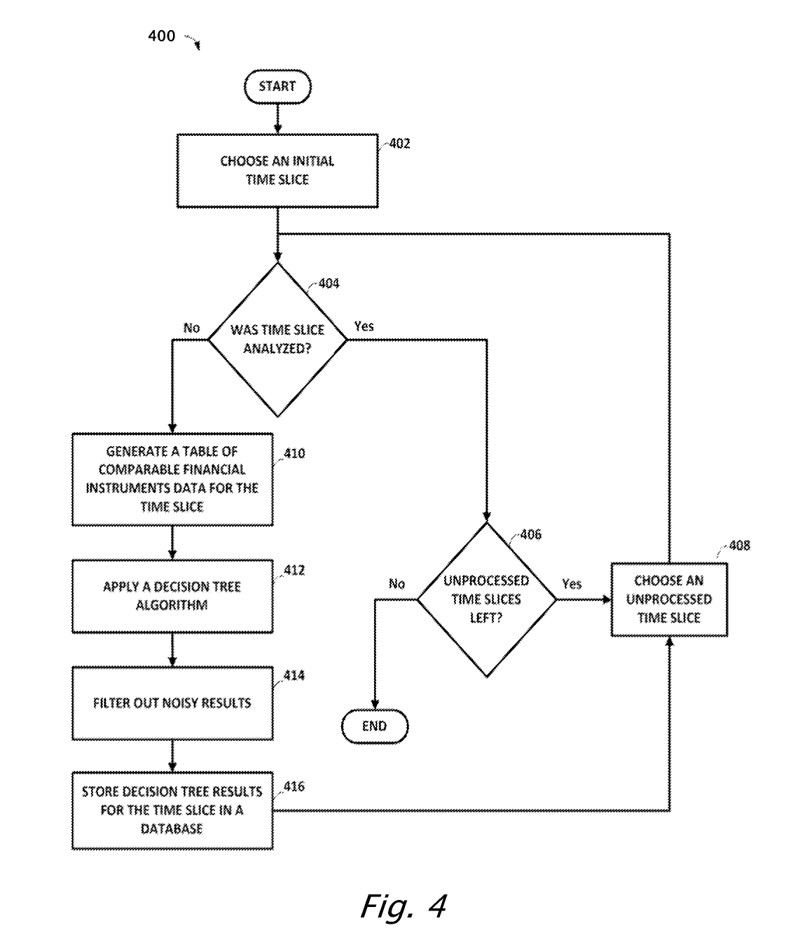

The table of classification results 140 is formed by applying classification procedures. A classification module 134 includes the classification procedures and is a component of the classifying server 104. The classification module 134 requests (136) and receives (138) trading data of publicly traded financial instruments and uses the data to generate the content of the table of classification results 140. To generate table of classification results 140, additional tables are formed including tables of comparable financial instrument data 142 and 148, and a table of raw patterns 144. The classification module 134 and the classification procedures will be described in greater detail further in the text referring to FIG. 4. It should be noted that if desired, the classification module 134 can be located on a different machine located remotely from the classifying server 104.

It should be noted that the table architecture is given by way of example only, and other data structures and architectures may be used within the scope of this invention.

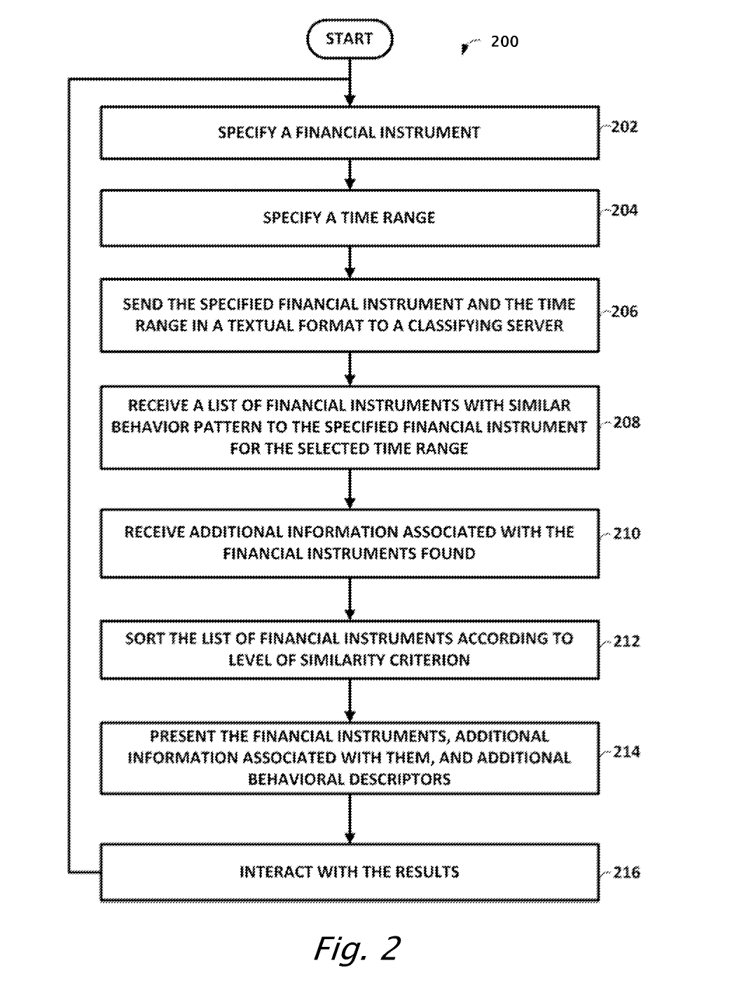

FIG. 2 provides one exemplary flow diagram for employing the financial instrument classification methods and system. As shown in block 202, the user 106 specifies a financial instrument at the user interface 112. The user 106 also specifies a time range 204 at the user interface 112. The financial instrument and the time range are sent to the classifying database 122, coupled to operate with classifying server 104, as shown in block 206. A list of financial instruments and additional details associated with the financial instruments are received from the classifying database 122, as shown in block 208. The list contains financial instruments that found to have similar behavior patterns to the financial instrument and the time range specified. The list is sorted according to level of similarity criterion 212 and presented at the user interface 112. Additional financial details 126 associated with the financial instruments are acquired 210, for example, Sharpe Ratio, Year-to-Date, 1-year, 3-year, 5-year, and 10-year performance, and Expense Ratios. The user 106 can interact with the results 216 and present the financial instruments and the additional associated details 214 in ascending/descending order according to the additional information values or according to the level of similarity of the financial instruments.

As an example, in one embodiment, a user may specify the time range Dec. 7, 2009-May 21, 2010 (24 weeks) and the financial instrument “CVX” (Chevron Corporation, a stock traded in NYSE) in the client computer 102. Immediately acquired from the database 122 a list of financial instruments with similar behavior to the specified financial instrument during the specified time period. The most similar financial instruments found are shown in Table A sorted in a descending order according to a similarity criterion. As can be seen from Table A, several of the financial instruments that are recognized as behaving similarly to Chevron Corporation are mutual funds (“DLDCX,” “DLDBX,” “DLDRX,” “EUGCX,” and “FSTEX”). Such a similarity demonstrates the ability of the financial instrument classification methods and system to classify financial instruments from different classes, i.e., a mutual fund to stock. Further, financial instruments from different sectors are found similar to Chevron Corporation (a company engaged in exploring for oil and natural gas) such as “CSC” (a company engaged in information technology) and “FFIN” (a company engaged in financial holding). Additionally, “FFIN” is traded in NASDAQ stock exchange and “CVX” is traded in NYSE stock exchange—such a similarity demonstrates the ability of the financial instrument classification methods and system to classify financial instruments not only from different sectors, but also from different stock exchanges.

TABLE A
An example for financial instruments acquired for
Chevron Corporation (“CVX”) for a time range
of 24 weeks (Dec. 7, 2009-May 21, 2010)

| Financial | | | Stock |
|---|---|---|---|
| Instrument | Description | Type | Exchange |
| CSC | Computer Sciences Corporation | Stock | NYSE |
| DLDCX | Dreyfus Natural Resources C | Mutual Fund | — |
| DLDBX | Dreyfus Natural Resources B | Mutual Fund | — |
| DLDRX | Dreyfus Natural Resources I | Mutual Fund | — |
| EUGCX | Morgan Stanley European Equity | Mutual Fund | — |
| | C | | |
| FFIN | First Financial Bankshares, Inc. | Stock | NASDAQ |
| FSTEX | Invesco Energy Inv | Mutual Fund | — |

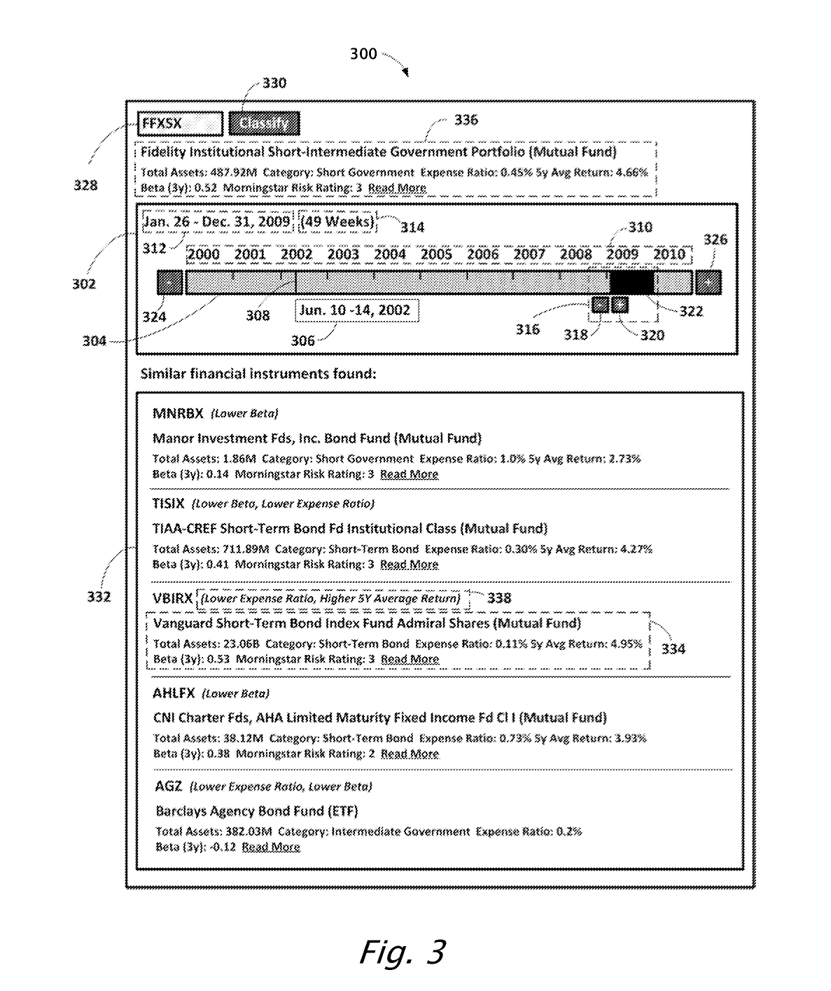

FIG. 3 depicts a non-limiting exemplary user interface 300 of one embodiment of the financial instrument classification methods and system. The exemplary user interface 300 serves as a layer of interaction and display for the client computer 102. A time range selection panel 302 is displayed by the client computer 102. The time range selection panel 302 includes a variety of display and interaction components. A time range selection canvas 304 is shown on the time range selection panel 302. The time range selection canvas 304 is an interactive rectangular-shaped control component that responds, for example, with no limitation, to events of a mouse 115 coupled to operate with client computer 102. In one embodiment of the methods, the time range selection canvas 304 includes vertical lines. Each vertical line represents a pre-defined time period (e.g., one week). The vertical lines are transparent and are an integrated part of the time range selection canvas 304. Hovering with mouse 115 above any single transparent vertical line shows a time range that represents the vertical line. For example, the time range 306 is shown while hovering above a vertical line 308 at the time range selection canvas 304. Clicking with mouse 115 on any single transparent vertical line sets the vertical line to be visible, as shown for example in 308. A set of labels 310 to help user 106 orient easily to selecting a time range is shown above the time range selection canvas 304. In one embodiment, the labels are titles of years.

Once the user 106 clicks with mouse 115 on a specific transparent vertical line, the line is set to be visible, and the time period associated with the vertical line is presented. Presentation of the selection is shown in blocks 312 and 314, where block 312 is a textual label presenting the time range selected and block 314 is a textual label presenting a numerical value. In one embodiment, the units of block 314 are given in weeks.

Clicking with mouse 115 on any single transparent vertical line on the time range selection canvas 304 also aligns a time range selection fixture 316 to the location of the vertical line, on which vertical line the user 106 clicks on the time range selection canvas 304. The time range selection fixture 316 is a component that includes a left button 318, a right button 320, and a time range selection pad 322. The time range selection pad 322 includes one or more visible vertical lines. Each vertical line represents a time period. In one embodiment, the time period of one vertical line is one week. Using the left button 318 and the right button 320 may determine the number of visible vertical lines the time range selection fixture 316 contains. In one embodiment, the time range selection pad 322 is one week (one vertical line), two weeks (two vertical lines), three weeks (three vertical lines), twelve weeks (twelve vertical lines), one quarter (approximately 13 vertical lines), one year (approximately 52 vertical lines) or any possible time range. Pressing on either the left button 318 or the right button 320 updates the presentation of the time period considered, as shown in blocks 312-314.

The time range selection fixture 316, including its sub-components—the left button 318, the right button 320, and the time range selection pad 322—may be aligned on any location on the time range selection canvas 304. One way to align the time range selection fixture 316 is to click with mouse 115 on any invisible vertical line on the time range selection canvas 304. Another way to align the range selection fixture 316 is to use buttons 324 and 326. Pressing on button 324 moves time range selection fixture 316, including its sub-components, one time period back. Pressing on button 326 moves time range selection fixture 316, including its sub-components, one time period ahead. In one embodiment, a single time movement is one week.

Once the user 106 specifies a time range using the various controls included in time range selection panel 302, he or she may type a financial instrument in an input text box 328. In one embodiment, pressing on button 330 sends the specified financial instrument 328 and the specified time range selected 312 to the classifying database 122. In an additional embodiment, button 330 is not necessary, and sending the specified financial instrument 328 and time range selected 312 is achieved by pressing a pre-defined key such as “ENTER” at a keyboard 117 coupled to operate with client computer 102. In another embodiment the user 106 may not have to type the entire string for the financial instrument in 328, instead, an autocomplete feature may be provided to pull financial instruments from the classifying database 122 upon partial string typing of a financial instrument. In another embodiment the user 106 may not have to type a financial instrument and/or time range, instead, a microphone would acquire the user's voice to specify the financial instrument and/or the time range. In another embodiment a camera coupled with a gesture recognition module would allow the user to specify the financial instrument and/or the time range via hand gestures and/or other human gestures. It should be noted that specifying time range in time range selection panel 302 and specifying the financial instrument 328 can be of any order, meaning—the user 106 may specify a financial instrument first and then a time range, or vice versa—he or she may specify a time range and then a financial instrument.

Panel 332 includes informative representations of the results as returned from the classifying database 122. Panel 332 contains a list of the financial instruments that are found behaving similarly to the specified financial instrument 328 in the time range selected 312. Additional characteristics and the characteristics' corresponding values associated with the financial instruments found, such as historical performance, fees and ranking are available at public database 128 and also presented in panel 332 next to each result, for example as in 334. Examples include Description, Type, Total Assets, Category, Expense Ratio, Beta, and Morningstar Risk Rating to name a few. Additional characteristics are also presented for the specified financial instrument 328 at 336. The additional characteristics and values 334 and 336 associated with the financial instruments are pulled from the public database 128 and/or from the classifying server 104. One of the characteristics 334 in panel 332 is a “Read More” interactive textual link. Clicking with a mouse 115 on a “Read More” link facilitates the user 106 to receive additional information for a financial instrument. The additional information can be pulled from the public database 128 or other external financial information systems/websites. In one embodiment the additional information is acquired from a website and presented using a standard web-browser.

Next to each similarly behaving financial instrument presented at panel 332 shown one or more indicators specifying the financial instrument's superiority 338 in comparison with the specified financial instrument 328. An indicator is an expression that represents a benefit between the specified financial instrument and each of the financial instruments found. For example, one of the results, “VBIRX,” has a lower expense ratio and a higher 5-year average return in comparison with “FFXSX.” The indicators for “VBIRX” will be then “Lower Expense Ratio” and “Higher 5Y Avg Return.” Another example for an indicator, “Lower Beta,” represents the difference in the financial risk, or beta, between two financial instruments. Financial risk is defined as the risk resulting from the existence of debt in the financing structure of the financial instrument. Financial instruments with high market risk will have required returns above the market rate, while those with low market risk will have lower rates of return. The indicators mentioned are examples and are not intended to suggest any limitation of the scope of use or functionality of the financial instrument classification methods and system.

In another embodiment, additional data associated with the specified financial 328 and the financial instruments found at panel 332 may be presented in a chart showing, for example, price/performance information such as nominal price, price change between two time steps, earnings, dividends, descriptive information such objective, analyst information, etc. Charts may ease understanding of the large quantities of data and the relationships/similarities between the financial instrument patterns. Line charts, bar charts and histograms are only a few examples that may be presented on the user interface 300 (see also 112).

### 4.3 Classification Method

To classify financial instruments, the classification module 134 is used as shown in FIG. 4. The classification module 134 is facilitated to perform a method that generates classification results stored in one or more tables in the classifying database 122. The classification method is applied on all of the price patterns of all financial instruments available. In one embodiment the available patterns are of all financial instruments traded in NASDAQ, NYSE, AMEX, and of approximately 20,000 American mutual funds traded over approximately one decade (2000-2010). In addition to table of classification results 140, classifying database 122 includes tables of comparable financial instrument data 142 and 148, and raw price patterns 144 for the financial instruments considered. The original patterns, i.e., trading patterns of financial instruments such as prices/volumes are requested 136 and received 138 by the classifying server 104. Once received, the patterns are stored and modified in classifying database 122 using a data preparation procedure as described through expressions 4.1-4.6. Real-time and daily financial instrument prices, fundamental company data, historical chart data, daily updates, fund summary, fund performance and dividend data stored in classifying database 122 are provided for example by companies such as Capital IQ, Commodity Systems, Inc. (CSI) and Morningstar, Inc. Additionally data can be acquired by using financial websites such as of the NASDAQ/NYSE stock exchanges, for example.

Assume S₁, S₂, Sᵢ, . . . Sₘ are m financial instruments considered for classification during a trading time range that includes n time-steps (e.g., a one time-step equals to a one day). Each financial instrument Sᵢ is associated with a vector of prices in which vector of prices each value represents an adjusted closing price for a business day ended in time-step tⱼ (j=1 to n). For a financial instrument Sᵢ the vector of prices, i.e., a signal/time series, is as follows:

$$\begin{matrix}{S}_{1} ( {P}_{{t}_{1}} , {P}_{{t}_{2}} , {P}_{{t}_{3}} , {P}_{{t}_{j}} , … {P}_{{t}_{n}} ) \\ {S}_{2} ( {P}_{{t}_{1}} , {P}_{{t}_{2}} , {P}_{{t}_{3}} , {P}_{{t}_{j}} , … {P}_{{t}_{n}} ) \\ … \\ {S}_{i} ( {P}_{{t}_{1}} , {P}_{{t}_{2}} , {P}_{{t}_{3}} , {P}_{{t}_{j}} , … {P}_{{t}_{n}} ) \\ … \\ {S}_{m} ( {P}_{{t}_{1}} , {P}_{{t}_{2}} , {P}_{{t}_{3}} , {P}_{{t}_{j}} , … {P}_{{t}_{n}} )\end{matrix} \qquad 4.1$$

For all financial instruments, generate vectors representing the change in price for every two subsequent trading days:

$$\begin{matrix}{S}_{1} ( \frac{{P}_{{t}_{2}}}{{P}_{{t}_{1}}} - 1 , \frac{{P}_{{t}_{3}}}{{P}_{{t}_{2}}} - 1 , \frac{{P}_{{t}_{4}}}{{P}_{{t}_{3}}} - 1 , … \frac{{P}_{{t}_{n}}}{{P}_{{t}_{n - 1}}} - 1 ) \\ {S}_{2} ( \frac{{P}_{{t}_{2}}}{{P}_{{t}_{1}}} - 1 , \frac{{P}_{{t}_{3}}}{{P}_{{t}_{2}}} - 1 , \frac{{P}_{{t}_{4}}}{{P}_{{t}_{3}}} - 1 , … \frac{{P}_{{t}_{n}}}{{P}_{{t}_{n - 1}}} - 1 ) \\ … \\ {S}_{i} ( \frac{{P}_{{t}_{2}}}{{P}_{{t}_{1}}} - 1 , \frac{{P}_{{t}_{3}}}{{P}_{{t}_{2}}} - 1 , \frac{{P}_{{t}_{4}}}{{P}_{{t}_{3}}} - 1 , … \frac{{P}_{{t}_{n}}}{{P}_{{t}_{n - 1}}} - 1 ) \\ … \\ {S}_{m} ( \frac{{P}_{{t}_{2}}}{{P}_{{t}_{1}}} - 1 , \frac{{P}_{{t}_{3}}}{{P}_{{t}_{2}}} - 1 , \frac{{P}_{{t}_{4}}}{{P}_{{t}_{3}}} - 1 , … \frac{{P}_{{t}_{n}}}{{P}_{{t}_{n - 1}}} - 1 )\end{matrix} \qquad 4.2$$

To simplify the representation of 4.2 it is presented as:

$$\begin{matrix}{S}_{1} [ {C}_{1} , {C}_{2} , {C}_{3} , … {C}_{n} ) ] \\ {S}_{2} [ {C}_{1} , {C}_{2} , {C}_{3} , … {C}_{n} ) ] \\ … \\ {S}_{i} [ {C}_{1} , {C}_{2} , {C}_{3} , … {C}_{n} ) ] \\ … \\ {S}_{m} [ {C}_{1} , {C}_{2} , {C}_{3} , … {C}_{n} ) ]\end{matrix} \qquad 4.3$$

The representation for the financial instruments S₁, S₂, Sᵢ, . . . Sₘ as in expression 4.3 facilitates comparing between them because this representation is price-scale and value-scale independent. Since n could be large (e.g., if classification for one decade is desired), time slices of a constant size h are defined. One reason to use time slices is to reduce the computation complexity—in practice, using too large number of input features in a classification algorithm may result unfeasible processing times. Splitting a signal into short time slices, performing classification for the shorter time slices separately and then applying a signal composition method as described further in this document, provides feasible classification processing times. Another reason to use smaller portions of long signals is provides better classification accuracy for certain problems.

h represents a set of C values (see 4.3 expressions). In one embodiment h=5, representing five business days (one week). Presenting 4.3 expressions as a collection of time slices of length h=5 results:

$$\begin{matrix}{{S}_{1} [ {C}_{1} , {C}_{2} , {C}_{3} , {C}_{4} , {C}_{5} ]}_{1} , {{S}_{1} [ {C}_{6} , {C}_{7} , {C}_{8} , {C}_{9} , {C}_{10} ]}_{2} , {{…S}_{1} [ {C}_{n - 4} , {C}_{n - 3} , {C}_{n - 2} , {C}_{n - 1} , {C}_{n} ]}_{k} \\ {{S}_{2} [ {C}_{1} , {C}_{2} , {C}_{3} , {C}_{4} , {C}_{5} ]}_{1} , {{S}_{2} [ {C}_{6} , {C}_{7} , {C}_{8} , {C}_{9} , {C}_{10} ]}_{2} , {{…S}_{2} [ {C}_{n - 4} , {C}_{n - 3} , {C}_{n - 2} , {C}_{n - 1} , {C}_{n} ]}_{k} \\ … \\ {{S}_{i} [ {C}_{1} , {C}_{2} , {C}_{3} , {C}_{4} , {C}_{5} ]}_{1} , {{S}_{i} [ {C}_{6} , {C}_{7} , {C}_{8} , {C}_{9} , {C}_{10} ]}_{2} , {{…S}_{i} [ {C}_{n - 4} , {C}_{n - 3} , {C}_{n - 2} , {C}_{n - 1} , {C}_{n} ]}_{k} \\ … \\ {{S}_{m} [ {C}_{1} , {C}_{2} , {C}_{3} , {C}_{4} , {C}_{5} ]}_{1} , {{S}_{m} [ {C}_{6} , {C}_{7} , {C}_{8} , {C}_{9} , {C}_{10} ]}_{2} , {{…S}_{m} [ {C}_{n - 4} , {C}_{n - 3} , {C}_{n - 2} , {C}_{n - 1} , {C}_{n} ]}_{k}\end{matrix} \qquad 4.4$$

where the size of the total time range of n time-steps, also equals to k time slices each of length of h=5. The following representation, for example, is considered for the first time slice (k=1):

$$\begin{matrix}{{S}_{1} [ {C}_{1} , {C}_{2} , {C}_{3} , {C}_{4} , {C}_{5} ]}_{1} \\ {{S}_{2} [ {C}_{1} , {C}_{2} , {C}_{3} , {C}_{4} , {C}_{5} ]}_{1} \\ … \\ {{S}_{i} [ {C}_{1} , {C}_{2} , {C}_{3} , {C}_{4} , {C}_{5} ]}_{1} \\ … \\ {{S}_{m} [ {C}_{1} , {C}_{2} , {C}_{3} , {C}_{4} , {C}_{5} ]}_{1}\end{matrix} \qquad 4.5$$

In the classification problem considered here no labels are available for the signals and there is no information on how to refer to a set of values associated with a certain time slice. As such, a numerical value representing each signal is generated and assigned as the label of the signal. The numerical value label denoted as LSᵢ is calculated for each signal:

$$\begin{matrix}{LS}_{1} = {\sum }_{l = 1}^{h} {S}_{1} ( {C}_{l} ) \\ {LS}_{2} = {\sum }_{l = 1}^{h} {S}_{2} ( {C}_{l} ) \\ … \\ {LS}_{i} = {\sum }_{l = 1}^{h} {S}_{i} ( {C}_{l} ) \\ … \\ {LS}_{m} = {\sum }_{l = 1}^{h} {S}_{m} ( {C}_{l} )\end{matrix} \qquad 4.6$$

The representation of self-labeling as shown in 4.6 expressions facilitates the application of supervised learning methods on unlabeled data sets. This is achieved by providing a supervised learning classification algorithm with pairs of adjusted representations of original signals (as shown as an example for k=1 in 4.5 expressions) and the adjusted representations' corresponding self-generated label (4.6 expressions).

The procedure described through expressions 4.1-4.6 is applied in one embodiment by acting several tables stored in classifying database 122. Prices and additional data are acquired for all the financial instruments considered. The data is stored in a first table 144—for each financial instrument, the following historical data is stored: 1) Symbol; 2) Date; 3) Opening Price; 4) Closing Price; 5) Volume, and; 6) Adjusted Closing Price, as seen for example in Table B.

TABLE B
Daily data for all financial instruments

| | | | | Adjusted | |
|---|---|---|---|---|---|
| | | Opening | Closing | Closing | |
| Symbol | Date | Price | Price | Price | Volume |
| EBAY | Jan. 3, 2000 | 130.13 | 141.25 | 17.66 | 48902400 |
| EBAY | Jan. 4, 2000 | 135.5 | 128 | 16 | 33803200 |
| EBAY | Jan. 5, 2000 | 121.25 | 136.56 | 17.07 | 44146400 |
| EBAY | Jan. 6, 2000 | 133.94 | 134.88 | 16.86 | 44147200 |
| EBAY | Jan. 7, 2000 | 134 | 134.75 | 16.84 | 21574400 |
| EBAY | Jan. 10, 2000 | 141.06 | 142.25 | 17.78 | 25056000 |
| EBAY | Jan. 11, 2000 | 142 | 139.19 | 17.4 | 22664000 |
| EBAY | Jan. 12, 2000 | 137.63 | 130.38 | 16.3 | 21400800 |
| EBAY | Jan. 13, 2000 | 133.5 | 137.81 | 17.23 | 19286400 |
| EBAY | Jan. 14, 2000 | 140.13 | 133.81 | 16.73 | 23342400 |
| . . . | . . . | . . . | . . . | . . . | . . . |
| AMZN | Jan. 3, 2000 | 81.5 | 89.38 | 89.38 | 16117600 |
| AMZN | Jan. 4, 2000 | 85.37 | 81.94 | 81.94 | 17487400 |
| AMZN | Jan. 5, 2000 | 70.5 | 69.75 | 69.75 | 38457400 |
| AMZN | Jan. 6, 2000 | 71.31 | 65.56 | 65.56 | 18752000 |
| AMZN | Jan. 7, 2000 | 67 | 69.56 | 69.56 | 10505400 |
| AMZN | Jan. 10, 2000 | 72.56 | 69.19 | 69.19 | 14757900 |
| AMZN | Jan. 11, 2000 | 66.88 | 66.75 | 66.75 | 10532700 |
| AMZN | Jan. 12, 2000 | 67.88 | 63.56 | 63.56 | 10804500 |
| AMZN | Jan. 13, 2000 | 64.94 | 65.94 | 65.94 | 10448100 |
| AMZN | Jan. 14, 2000 | 66.75 | 64.25 | 64.25 | 6853600 |
| . . . | . . . | . . . | . . . | . . . | . . . |

Table 144 generates a second table 146 with a distinct column of financial instruments and additional columns, each representing a title for a single trading day and the contents of each cell representing the adjusted close price of the financial instrument for the trading day (see 4.1 expressions). In one embodiment, a column name for a trading day is in the format of “Day_Month_Year,” for example, “20_{—}8_{—}2008.” An example is shown in Table C.

TABLE C
Daily prices for all financial instruments

| Symbol | . . . | 7_1_2000 | 10_1_2000 | 11_1_2000 | 12_1_2000 | 13_1_2000 | . . . |
|---|---|---|---|---|---|---|---|
| EBAY | . . . | 16.84 | 17.78 | 17.4 | 16.3 | 17.23 | . . . |
| AMZN | . . . | 69.56 | 69.19 | 66.75 | 63.56 | 65.94 | . . . |
| . . . | . . . | . . . | . . . | . . . . | . . . | . . . | . . . |

Table 146 generates table 148 (see example in Table D) with a distinct column of financial instruments and additional columns, each column representing a price difference in percent between the adjusted close price of two subsequent days (see 4.2 and 4.3 expressions). In one embodiment, the column names for the difference are in the format of “MonthTitle_TradingDay_PreviousTradingDay_Year,” for example, “October_{—}13_{—}12_{—}2010.” An example is shown in Table D.

TABLE D
Daily price change (%) for all financial instruments

| Symbol | . . . | Jan_10_7_2000 | Jan_11_10_2000 | Jan_12_11_2000 | Jan_13_12_2000 | Jan_14_13_2000 | . . . |
|---|---|---|---|---|---|---|---|
| EBAY | . . . | 5.58 | −2.14 | −6.32 | 5.71 | −2.9 | . . . |
| AMZN | . . . | −0.53 | −3.53 | −4.78 | 3.74 | −2.56 | . . . |
| . . . | . . . | . . . | . . . . | . . . | . . . | . . . | . . . |

The data stored in table 148 may serve as a data set for a machine learning algorithm. In one embodiment, the data in table 148 may serve as an input set for a supervised learning algorithm using the stored comparable numerical values as input. In another embodiment as described herein, the supervised learning algorithm is a decision tree algorithm. In yet another embodiment, the data in table 148 may serve as input for an unsupervised learning algorithm or a reinforcement learning algorithm.

The classification method 400 shown in FIG. 4 considers a large number of time slices. For example, if the desired classification time range is a certain quarter, then the number of time slices considered is approximately twelve (assuming that the length of a time slice is one week). Classification considers all patterns of financial instruments stored in table 148. Each time slice has a starting date and an ending date. In one embodiment, the time slice is five business days configured in advance (one week—Monday through Friday). It should be noted that in one embodiment the classification method 400 can be applied on financial instruments as trading occurs, and in which financial instruments the duration of a time slice is shorter, e.g., one millisecond, or longer, e.g., one month. The classification method 400 starts with classifying data of an initial time slice 402. If classification results already exist for the time slice as evaluated in 404, the procedure evaluates whether classification has not been applied yet for additional time slices considered, as shown in 406. If all time slices have been processed, the procedure ends. If there are time slices that have not been processed yet, the next time slice is considered, as shown in block 408.

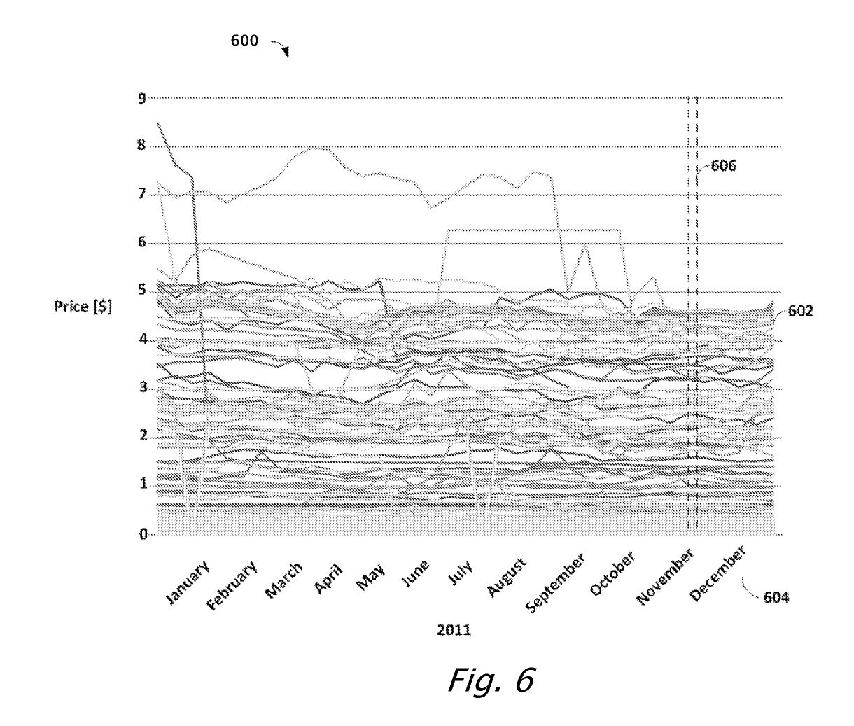

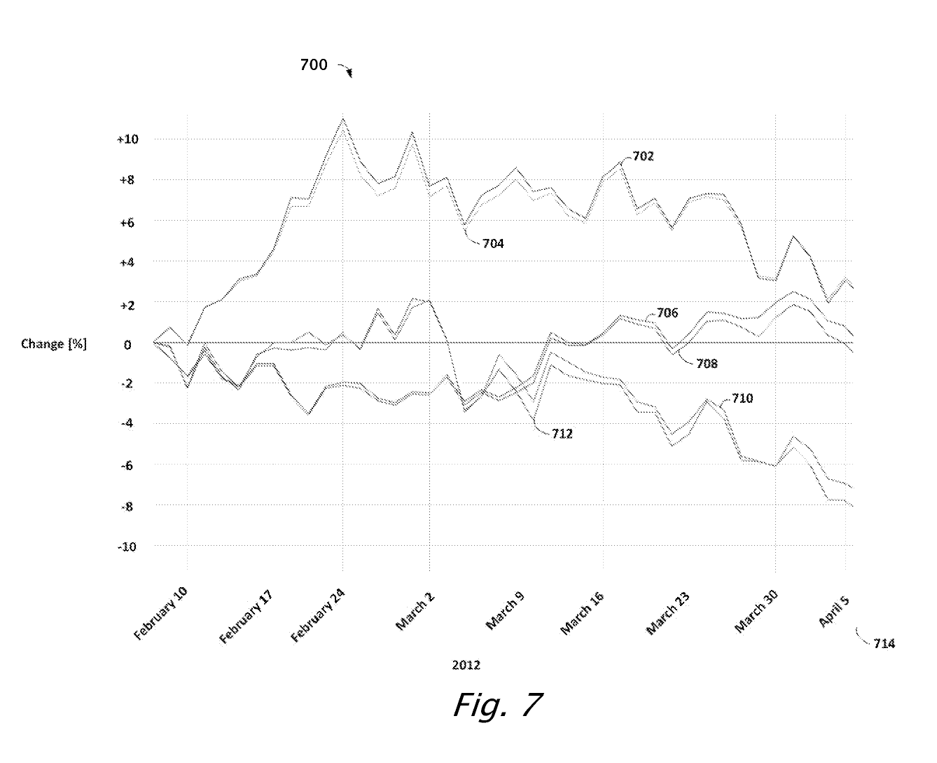

Exemplary time series 602 representing prices of several dozens of financial instruments are presented in FIG. 6. The time range 604 shown in FIG. 6 includes approximately 52 weeks of 2011. Each week, i.e., five business days, considered as a time slice. An exemplary time slice 606 is marked for one week during November 2011. An exemplary grouping of time series is presented in FIG. 7. The time series represent six financial instruments traded over a period 714 of approximately three months in 2012. Three groups of financial instruments are shown: 1) OIL 702 and USO 704, 2) PIREX 706 and GRERX 708, and 3) GZIIX 710 and EWZ 712.

For any time slice, for which time slice the classification results are not yet available, table 142 is generated, as shown in block 410. Table 142 consists of a portion of table 148. The structure of table 142 depends on the occurrence and duration of the time slice considered. For example, for the time slice Apr. 20-Apr. 24, 2009 (a total of five trading days), table 142 consists of a financial instrument symbol column and numerical value columns denoted as “Features” (4.2 expressions): 1) “April_{—}20_{—}17_{—}2009,” 2) “April_{—}21_{—}20_{—}2009,” 3) “April_{—}22_{—}21_{—}2009,” 4) “April_{—}23_{—}22_{—}2009,” and 5) “April_{—}24_{—}23_{—}2009.” Values in these columns are as in table 148. An additional column in table 142 is titled “Predictor,” or “Label.” “Predictor” values are a function of the other numerical values for a financial instrument. In one embodiment, values in “Predictor” are a summation (4.6 expressions). In the previous example of the time period Apr. 20-Apr. 24, 2009, numerical values in “Predictor” for a financial instrument are equal to summing the values of “April_{—}20_{—}17_{—}2009,” “April_{—}21_{—}20_{—}2009,” “April_{—}22_{—}21_{—}2009,” “April_{—}23_{—}22_{—}2009,” and “April_{—}24_{—}23_{—}2009.” In another embodiment, values in “Predictor” are an average of the numerical values of the features. In yet another embodiment, time periods may exclude one or more trading days, such as when a holiday occurs. It should be noted that the number of records in table 142 equals the number of financial instruments considered. An example for table 142 for Apr. 20-Apr. 24, 2009 is shown in Table E.

TABLE E
A comparable table example (values are in %) for Apr. 20-Apr. 24, 2009

| | April_{—} | April_{—} | April_{—} | April_{—} | April_{—} | |
|---|---|---|---|---|---|---|
| Symbol | 20_17_2009 | 21_20_2009 | 22_21_2009 | 23_22_2009 | 24_23_2009 | Predictor |
| GOOG | −3.3 | 0.57 | 0.63 | 0.22 | 1.25 | −0.63 |
| MSFT | −3.08 | 1.93 | −1 | 0.79 | 10.5 | 9.13 |
| . . . | . . . | . . . | . . . . | . . . | . . . | . . . |

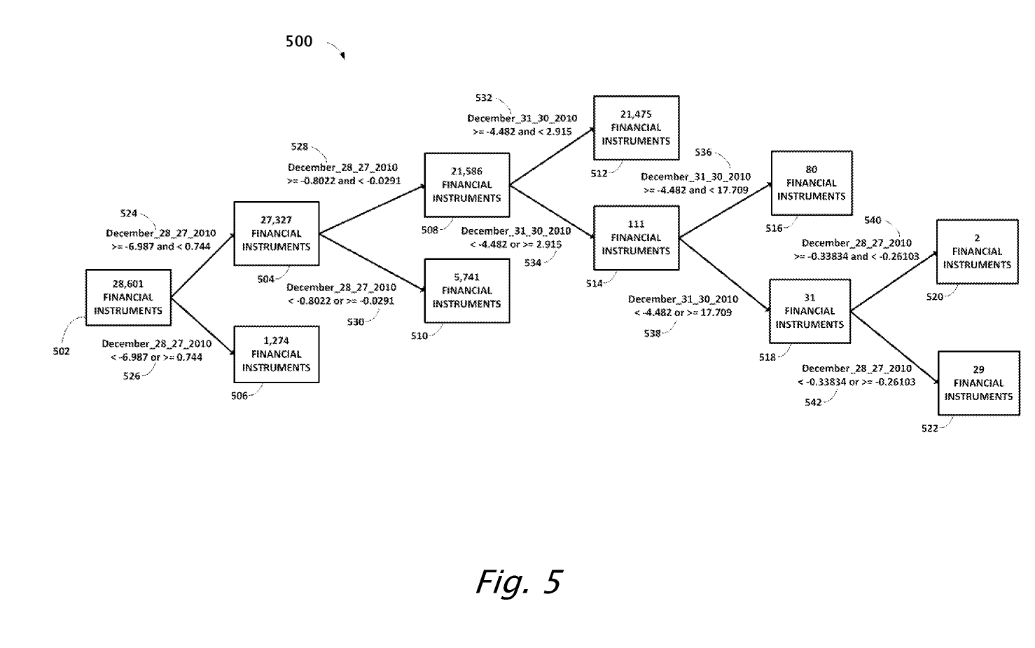

The data of table 142 serves as an input for a standard supervised learning algorithm. In one embodiment, the supervised learning algorithm is a decision tree algorithm 412. For each time slice, a decision tree is generated. An example for a partial representation of a decision tree is shown in FIG. 5. A decision tree is a data structure that consists of branches and leaves. Leaves (also denoted as “nodes”) represent classifications, and branches represent conjunctions of features that lead to those classifications. In one embodiment each node has a unique title to distinguish the node from other nodes that the tree is composed. A node contains two or more records. Each record represents a financial instrument, its feature values (4.2 expressions) and its predictor value (4.6 expressions). The fewer financial instrument records in a node (the minimum is two), the less this node varies, i.e., a node with fewer records is more likely to represent a better classification between the financial instruments that the node contains.

The number of nodes in a generated tree depends on the length of the time slice and the number of financial instruments considered. The classification accuracy of the algorithm depends on its input parameters. In one embodiment, parameters for a decision tree algorithm include complexity penalty, to control the growth of the decision tree, and minimum support, to determine the minimal number of leaf cases required to generate a split. Setting the desired values for the decision tree algorithm parameters depends on the tradeoff between classification accuracy and computational speed. Classifying with perfect or close to perfect accuracy thousands or hundreds of thousands of financial instruments, may require many days or even many weeks to apply a decision tree algorithm using the classification method herein. To reduce the calculation time, the growth of the decision tree is controlled by increasing the complexity penalty level (this decreases the number of splits) and by increasing the level of minimum support. On one hand, controlling the growth of the tree improves computation performance. On the other hand, controlling the growth of the tree may affect classification accuracy. A filtering procedure 414 is applied to each decision tree generated to partially overcome this and to avoid recognizing groups of financial instruments that behave differently from each other but are still classified as similar. In one embodiment, for each tree, the predictor value of each financial instrument in a node is compared with the other predictors of the financial instruments present in the node. If the variability of predictors found in a node is above a pre-defined threshold, then the node is considered a noisy/inaccurate classification, i.e., the node is pruned.

In one embodiment 28,601 financial instruments are considered for classification including several thousands of NASDAQ, NYSE, and AMEX financial instruments, several market indexes, and approximately 20,000 American mutual funds. The total time range for classification is 574 weeks (approximately one decade) spanning from Monday Jan. 3, 2000 to Friday Dec. 31, 2010. For most of the financial instruments considered trading information was available for the entire time range, however, for certain stocks and mutual funds data was available only when they first became available for trading (e.g., Google Inc. went public in August 2004). For each of the 574 weeks, a decision tree based classification is performed using the data of table 142. Each such classification results a decision tree data structure. For the amount of data considered here, a typical size for one decision tree is in the range of 5,000 to 10,000 nodes. An exemplary partial representation for a decision tree 500 plotting only several nodes 502-522 is shown in FIG. 5. The decision tree 500 includes a main node 502 that contains all financial instruments. The decision tree algorithm generates rules as shown in 524-542. The rules are based on values for the financial instruments (price change given in percent) for every two subsequent trading days; see as described through 4.1-4.6 expressions. Some nodes in the tree split to two sub-nodes, i.e., children, and other nodes do not. A split, if occurs, is based on the generated rules and separates a group of financial instruments to two smaller groups. For example, for the main node 502 that consists of 28,601 financial instruments, two rules were generated—rule “December_{—}28_{—}27_{—}2010>=−6.987 and <0.744” 524 and rule “December_{—}28_{—}27_{—}2010<−6.987 or >=0.744” 526. Rule 524 generates a sub-node that contains 27,327 financial instruments 504 and rule 526 generates a sub-node that contains 1,274 financial instruments 506. Similarly, other generated rules split nodes across the tree as in 528-542. For a financial instrument to be considered classified to a certain node, the series of rules that lead to that node are considered—for example, the two financial instruments of node 520 are classified using a series of five rules starting from the main node 502 as shown below.

“December_{—}28_{—}27_{—}2010>=−6.987 and <0.744” (as shown in 524).

“December_{—}28_{—}27_{—}2010>=−0.8022 and <−0.0291” (as shown in 528).

“December_{—}31_{—}30_{—}2010<−4.482 or >=2.915” (as shown in 534).

“December_{—}31_{—}30_{—}2010<−4.482 or >=17.709” (as shown in 538).

“December_{—}28_{—}27_{—}2010>=−0.33834 and <−0.26103” (as shown in 540).

Table F shows the content of node 520. The content includes the symbols of the two financial instruments in the node, “DRQAX,” and “DRQLX,” change in price vectors, and the financial instruments' corresponding Predictor. It should be noted that the decision tree algorithm applies a feature selection procedure to identify the attributes and values that provide the most information. As such, it is typical for a set of rules generated not to include all of the available features. For example, in generating the five rules mentioned in the above example, only two out of the five possible features are considered—“December_{—}28_{—}27_{—}2010,” and “December_{—}31_{—}30_{—}2010.” It also should be mentioned that occasionally rules that determine a classification for a certain node may overlap. For example, for the two financial instruments of node 520 only rules “December_{—}28_{—}27_{—}2010>=−0.33834 and <−0.26103” (as shown in 540) and “December_{—}31_{—}30_{—}2010<−4.482 or >=17.709” (as shown in 538) are necessary, while the other three are redundant.

TABLE F
An example for the content of a decision tree node

| | December_{—} | December_{—} | December_{—} | December_{—} | December_{—} | |
|---|---|---|---|---|---|---|
| Symbol | 27_23_2010 | 28_27_2010 | 29_28_2010 | 30_29_2010 | 31_30_2010 | Predictor |
| DRQAX | 0 | −0.12 | 0.49 | 11.89 | −10.41 | 1.85 |
| DRQLX | 0 | −0.12 | 0.49 | 11.92 | −10.43 | 1.86 |

The decision tree classification results for the time slice considered, excluding noisy data, are stored 416 in table of classification results 140 of classifying database 122 of the classifying server 104. Table G is an exemplary partial representation of the table of classification results 140 for one business week. For the amount of data considered here, the number of records representing the nodes of one decision tree classification results is in the range of 10,000 to 70,000 records.

TABLE G
An example for a tabular representation of
one decision tree classification results

| Node Name | Symbol |
|---|---|
| A | MMEBX |
| A | MMEKX |
| B | DSPIX |
| B | NMIAX |
| B | SHRAX |
| B | TWSIX |
| C | TWCIX |
| C | FAEIX |
| D | AELIX |
| D | FEIIX |
| D | GTMUX |
| D | SSFFX |
| D | STCSX |
| D | XGAMX |
| . . . | . . . |

The procedure repeats itself with the next time slice 408 until all time slices are processed and decision trees are created for them and added in a tabular format to the table of classification results 140 as shown for example in Table H. Table 140 includes the following records of data: 1) Period ID—an integer specifying the time period title considered; 2) Period Title—a string specifying the time period title considered; 3) Node Name—a unique name for the node, and; 4) Symbol—the financial instrument symbol. For the amount of data considered here, the number of records in table 140 is approximately 18 million.

TABLE H
An example for a tabular representation of
all decision tree classification results

| Period ID | Period Title | Node Name | Symbol |
|---|---|---|---|
| 1 | Jan. 03-Jan. | A | MMEBX |
| | 07, 2000 | A | MMEKX |
| | | B | DSPIX |
| | | B | NMIAX |
| | | B | SHRAX |
| | | B | TWSIX |
| | | C | TWCIX |
| | | C | FAEIX |
| | | D | CSIEX |
| | | D | KNIEX |
| | | D | MASRX |
| | | D | SWANX |
| | | . . . | . . . |
| 2 | Jan. 10-Jan. | A | XNXCX |
| | 14, 2000 | A | XNXNX |
| | | B | TMMDX |
| | | B | CFSTX |
| | | C | FCAMX |
| | | C | PFOAX |
| | | D | ABHYX |
| | | D | APFBX |
| | | D | FINIX |
| | | D | IFLBX |
| | | . . . | . . . |

. . .

| | | | |
|---|---|---|---|
| 574 | Dec. 27-Dec. | A | DX |
| | 31, 2010 | A | MGGIX |
| | | B | FIVZ |
| | | B | PONCX |
| | | C | OBFVX |
| | | C | VWNAX |
| | | D | PKB |
| | | D | STFBX |
| | | D | XCHYX |
| | | . . . | . . . |

The classification method 400 shall be performed only once. When the classification method 400 is completed and the table of classification results 140 is created in classifying database 122, user 106 may query table 140 using the client computer 102 as previously described within the context of FIG. 1.

To receive classification results from classifying database 122, Algorithm A is applied. Consider a financial instrument and a time range specified by the user 106. The financial instrument is denoted as S and the time range is represented by a set of t decision trees each representing one time slice classification. Note that, as mentioned previously, nodes with variability of predictors above a pre-defined threshold are not considered.

Algorithm A: Similarity ranking algorithm

Given a set of T₁ , T₂ , ... Tₜ trees
For each tree Tᵢ (i = 1 to t) each contains N(Tᵢ) nodes

Find all k nodes Nⱼ(Tᵢ) ( j = 1 to k ) that contain S
Find financial instruments in a node and increase by 1 a counter

value associated with each financial instrument.
Sort the financial instruments in a descending order according to the total
counter value of a financial instrument.

The following example demonstrates applying Algorithm A on exemplary financial instrument “GOLDX” in one time slice, Jul. 20-24, 2009. Out of 7,707 nodes of the decision tree, three nodes contain “GOLDX:” 1) “GOLDX,” “GLDAX,” “GLDBX,” “GLDIX,” “TOLCX,” “TOLIX,” “TOLLX,” 2) “GOLDX,” “GLDAX,” “GLDIX,” “TOLCX,” “TOLLX,” and 3) “GOLDX,” “GLDAX,” “GLDIX.” The classification is summarized in Table I—the higher the “Counter” value for a financial instrument, the more similar the financial instrument is to the financial instrument and the time range specified, i.e., the financial instrument is ranked higher. As seen in Table I, financial instruments “GLDIX” and “GLDAX” are the most similarly behaving to “GOLDX” during Jul. 20-24, 2009. “TOLCX” and “TOLLX” are also considered as similarly behaving to “GOLDX” but less similar in comparison with “GLDIX” and “GLDAX.” “TOLIX” and “GLDBX” are also considered as similarly behaving to “GOLDX” but are considered less similar in comparison with the rest of the financial instruments specified in Table I.

TABLE I
Classification example for “GOLDX” for one time slice (1 week)

| Symbol | Counter |
|---|---|
| GOLDX | 3 |
| GLDIX | 3 |
| GLDAX | 3 |
| TOLCX | 2 |
| TOLLX | 2 |
| TOLIX | 1 |
| GLDBX | 1 |

Two financial instruments are defined as similarly behaving when the difference in price change (given in percent) between the financial instruments at two subsequent trading pre-defined time units (e.g., two days) is smaller than a pre-defined threshold value. Say there are two financial instruments—Financial Instrument A, and Financial Instrument B traded on some Monday and on the following day, Tuesday. Financial Instrument A is considered as similarly behaving to Financial Instrument B when the value of subtracting the price change value (given in percent) between Monday and Tuesday for Financial Instrument A by the price change value (given in percent) between Monday and Tuesday for Financial Instrument B is smaller than a pre-defined threshold value. For longer period (e.g., one month), two financial instruments are defined as similarly behaving when in any two subsequent trading time units (e.g., two days), the difference in price change (given in percent) between the financial instruments is smaller than a pre-defined threshold value. It should be noted that in one embodiment, the subsequent trading time units could be different than a day, e.g., one second, or one year.

In another example, Algorithm A is applied on an exemplary financial instrument “GOLDX” for Jul. 20, 2009-Mar. 5, 2010 (33 weeks, i.e., 33 time slices). For a total of 252,423 nodes contained in the 33 decision trees, classification results are generated as shown in Table J.

To measure the level of similarity between a specified financial instrument to another financial instrument a Similarity Rank (SR) was defined. The column “Similarity Rank” in Table J contains similarity rank values calculated between “GOLDX” to other financial instruments that were classified as similarly behaving to “GOLDX”. The SR is calculated by dividing the counter value of the similarly behaving financial instrument found to the counter value of the specified financial instrument. The SR value, for example, between “GOLDX” and “GLDAX”, equals to 47/60=0.78, and the SR value between “GOLDX” and “FGDTX” equals to 11/60=0.18. SR values are in the range of 0 to 1 while the closest the value to 1, the more similarly behaving two financial instruments are.

TABLE J
Classification example for “GOLDX”
for multiple time slices (33 weeks)

| | | Similarity |
|---|---|---|
| Symbol | Counter | Rank |
| GOLDX | 60 | 1.0 |
| GLDAX | 47 | 0.78 |
| GLDIX | 42 | 0.70 |
| GLDCX | 37 | 0.62 |
| GLDBX | 36 | 0.60 |
| USAGX | 17 | 0.28 |
| IIGCX | 16 | 0.27 |
| INIVX | 14 | 0.23 |
| ACGGX | 13 | 0.22 |
| BGEIX | 13 | 0.22 |
| AGGNX | 12 | 0.20 |
| FGDIX | 12 | 0.20 |
| FSAGX | 12 | 0.20 |
| OCMGX | 12 | 0.20 |
| FGDTX | 11 | 0.18 |
| AGYBX | 10 | 0.17 |
| AGYCX | 10 | 0.17 |
| AGGWX | 9 | 0.15 |
| EKWAX | 9 | 0.15 |
| EKWCX | 9 | 0.15 |
| FGDCX | 9 | 0.15 |
| INIIX | 8 | 0.13 |
| IGDYX | 8 | 0.13 |
| IGDAX | 8 | 0.13 |
| FGDBX | 8 | 0.13 |
| EKWBX | 8 | 0.13 |
| SCGDX | 8 | 0.13 |
| SGDAX | 8 | 0.13 |
| SGDCX | 8 | 0.13 |
| SGDBX | 7 | 0.12 |
| TGLDX | 6 | 0.10 |
| RPMCX | 6 | 0.10 |
| FGLDX | 6 | 0.10 |
| EKWYX | 6 | 0.10 |
| INPBX | 6 | 0.10 |
| INPMX | 6 | 0.10 |
| IGDBX | 5 | 0.08 |
| IGDCX | 5 | 0.08 |
| GDX | 5 | 0.08 |
| FGDAX | 5 | 0.08 |
| UNWPX | 4 | 0.07 |
| SGDIX | 3 | 0.05 |
| SGGDX | 3 | 0.05 |
| FEGIX | 3 | 0.05 |
| FEGOX | 3 | 0.05 |
| CHA | 2 | 0.03 |
| TOLLX | 2 | 0.03 |
| TOLCX | 2 | 0.03 |
| RYMBX | 2 | 0.03 |
| RYMEX | 2 | 0.03 |
| RYMNX | 2 | 0.03 |
| RYMPX | 2 | 0.03 |
| RYPMX | 2 | 0.03 |
| RYZCX | 2 | 0.03 |
| OGMBX | 2 | 0.03 |
| OGMNX | 2 | 0.03 |
| RGLD | 2 | 0.03 |
| TOLIX | 1 | 0.02 |
| DWGOX | 1 | 0.02 |
| EZA | 1 | 0.02 |
| HYV | 1 | 0.02 |

It should be noted that other classification methods to calculate similarity are well known in the art. Examples include Neural Networks, Discrete Fourier Transform, and Support Vector Machines. It should also be noted that other measures to determine the level of similarity between two signals, are well known in the art. Examples include the correntropy coefficient, the SimilB, and the well-established Pearson product-moment correlation coefficient. The Similarity Rank values calculated herein represent the level of similarity between two financial instruments. Potential extensions to the Similarity Rank would be, for example, an “Inverse Similarity Rank” that represents an inverse correlation, or a “Randomness Similarity Rank” that represents a random correlation between two signals. The Similarity Rank is one example and is not intended to suggest any limitation of the scope of use or functionality of the financial instrument classification method.

The decision tree algorithm 412 used along with the financial instrument classification methods and system is well known in the art and need not be discussed at length here. It should be mentioned that other methods may be used instead of or in addition to the decision tree algorithm 412. Examples include supervised learning (e.g., artificial neural networks, genetic algorithms, support vector machines, and Bayesian networks), unsupervised learning (e.g., self-organizing maps and adaptive resonance theory), and reinforcement learning (e.g., Collaborative Q-learning). Additional methods include data processing processes, statistical processes, and signal processing (e.g., correlation).

Providing classifications for signals or time series is also known by those with ordinary skill in the art; however, what is novel is using the financial instrument classification methods and system by a client computer and a server to provide financial instruments that behave similarly to a single financial instrument specified along with a time range. Additional novelty described herein through 4.1-4.6 expressions is a self-labeling enhancement that facilitates the application of supervised learning methods on unlabeled data sets. Another novelty described herein facilitates classifying long time series (of any length)—Algorithm A as applied on multiple time slices, reflects a signal composition method as the algorithm combines the classification results of separated short-length time ranges. The composition facilitates evaluating the level of similarity between the behaviors of time series for extended periods of time.

Although the above description relates to classification of financial instruments, those with ordinary skill in the art for which the claimed method is made, shall realize that alternate embodiments are possible. For example, the proposed methods and system can be applied to a series of non-financial behavioral patterns such as seismic patterns. It is also important to mention that classification of financial instruments can be achieved by using methods other than decision tree learning algorithm as long as similarities in behavior patterns can be identified. Additionally, a server or engine which is not based on machine learning techniques can possibly be used as long as there is a way to determine similarities between time series or signal patterns. Lastly, although the discussion above refers to a machine learning server or engine accessed over a network, it should be realized that the application can run locally on the user's computer. The methods and system may operate in a cloud computing environment where the methods are executed in the cloud and communication between the cloud and the computing device occurs over a network.

### 4.4 The Computing Environment

The financial instrument classification methods and system are designed to be used in a computing environment. The following description provides a brief, general description of a suitable computing environment in which environment the financial instrument classification methods and system can be implemented. The methods are operational with numerous general-purpose or special-purpose computing system environments or configurations. Examples of well-known computing systems, environments, and/or configurations that may be suitable include, but are not limited to, personal computers, server computers, hand-held or laptop devices (e.g., notebook computers, cellular phones, smart phones, and personal data assistants), mainframe computers and distributed or cloud computing environments that include any of the above systems or devices.

It should be noted that the use of common computer components, such as mouse and keyboard is made by way of example only. Computer input devices such as a mouse, a keyboard, a touchscreen, a microphone, a camera, and the like may be used interchangeably. Similarly, computer output devices such as a display, a printer and the like may be used interchangeably.

It should be noted that the financial instrument classification methods and system may be described in the general context of computer-executable instructions, such as program modules, as being executed by a general purpose computing device. Generally, program modules include routines, programs, objects, components, data structures, and so on, that perform particular tasks or implement particular abstract data types. The financial instrument classification methods and system may be practiced in distributed computing environments where tasks are performed by remote processing devices linked through a communication network. In a distributed computing environment, program modules may be located in both local and remote computer storage media, including memory storage devices.

It should also be noted that any or all of the aforementioned alternate embodiments may be used in any combination desired to form additional hybrid embodiments. Although the subject matter has been described in language specific to structural features and/or methodological acts, it is to be understood that the subject matter defined in the appended claims is not necessarily limited to the specific features or acts described. The specific features and acts described are disclosed as example forms of implementing the claims.

What is claimed is:

1. A classification method for selecting financial instruments, performed by a computer processor, the method comprising the steps of:
a) specifying a particular financial instrument;
b) specifying one or more screening criteria;
c) querying a database, coupled to operate with the computer processor, with said particular financial instrument and said screening criteria; and
d) retrieving financial instruments from said database that behave similarly to said particular financial instrument and said screening criteria, to thereby obtain acquired financial instruments.

2. The classification method of claim 1, wherein said similarity of behavior of said particular financial instrument is determined by calculating a ranking measure, wherein the higher is said ranking measure, between said particular financial instrument and one of said acquired financial instruments, the more similarly behaving said two financial instruments are.

3. The classification method of claim 1, wherein one of said screening criteria is a time range determined by a starting time and an ending time.

4. The classification method of claim 1, wherein said acquired financial instruments are presented in a descending order, according to similarity rank results, while the most similar is presented first.

5. The classification method of claim 1, wherein said particular financial instrument and said acquired financial instruments include sets of time-dependent numbers that represent prices for said financial instruments; and wherein said prices for a financial instrument, selected from the group consisting of said particular financial instrument and said acquired financial instruments, are adjusted to represent the effect of benefits provided by said financial instruments.

6. The classification method of claim 1, wherein said particular financial instrument includes a set of time-dependent numbers that represent prices for a market index, and wherein said market index is an aggregated value obtained from a weighted sum of said acquired financial instruments and expressing the total values of said acquired financial instruments against a base value from a specific date.

7. The classification method of claim 1, wherein each of said acquired financial instruments is coupled with one or more indicators associated with said particular financial instrument and said screening criteria.

8. The classification method of claim 7, wherein said indicator is selected from a group of expressions including an expression that represents the difference in fees between said specified financial instrument and said acquired similarly behaving financial instrument; an expression that represents the difference in return between said specified financial instrument and said acquired similarly behaving financial instrument; and an expression that represents the difference in risk between said specified financial instrument and said acquired similarly behaving financial instrument.

9. The classification method of claim 1 further comprising the step of displaying said acquired financial instruments on a display unit coupled to operate with the computer processor.

10. The classification method of claim 1, wherein said acquired financial instruments are acquired from a remote database, over a data network.

11. The classification method of claim 1, wherein each of said financial instruments includes a set of derived time-dependent numbers that represent returns for each of said respective financial instrument.

12. The classification method of claim 1, wherein said particular financial instrument and/or said acquired financial instruments are abbreviations used to uniquely identify publicly traded financial instruments, or abbreviations used to uniquely identify custom generated time series representing hypothetical trading.

13. A computer software product for interactively selecting financial instruments, the computer software product embodied in a non-transitory computer-readable medium in which program instructions are stored, wherein the program instructions, when read by a computer processor, perform a classification method comprising the steps of:
a) selecting a financial instrument;
b) specifying one or more screening criteria;
c) querying a database, coupled to operate with the computer processor, with said selected financial instrument and said screening criteria; and
d) retrieving matched financial instruments that behave similarly to said selected financial instrument and said screening criteria, from said database.

14. The computer software product of claim 13 further comprising the step of storing said matched financial instruments.

15. The computer software product of claim 13 wherein said screening criteria comprise a time range.

16. The computer software product of claim 13 further comprising the step of storing in said database additional behavioral descriptors for said specified financial instrument and for said matched financial instruments.

17. The computer software product of claim 13 further comprising the step of sending a financial instrument and additional criteria over a network between the computer processor and said database.

18. The computer software product of claim 13 further comprising a user interface that facilitates a user to specify a financial instrument and additional criteria, as well as to view similarly behaving financial instruments and additional behavioral descriptors.

19. A system for classifying financial instruments, comprising:
a) a classifying server having a server processor and a classifying database;
b) at least one user computer terminal, including a display; and
c) a public financial instruments database operatively connected to said classifying server,
wherein said user computer facilitates a user to send a request to said classifying server and wherein said request includes a specific financial instrument and one or more screening criteria; and
wherein said classifying server is facilitated:
a) to identify in said public financial instruments database financial instruments that behave similarly to said specific financial instrument according to said screening criteria;
b) to calculate a similarity ranking measure between every two financial instruments to thereby create classification results;
c) to store said classification results in said classifying database; and
d) to send said classification results to said user computer.

20. A method for grouping time series over a pre-defined time range, wherein a time series is a sequence of values, the method comprising the steps of:
a) splitting said time range into a collection of time slices;
b) for each time series in each of said time slices performing the following steps:
i. generating a modified time series comprising value differences between every two subsequent values of the time series; and
ii. calculating a numerical value representing said time series denoted as a label, wherein said numerical value is a summation of said values of said modified time series at said time slice considered;
c) applying a classification algorithm on said time slice data points where the inputs for said algorithm are said modified time series and said respective calculated labels, thereby creating different groups of time series, wherein each group contains similarly behaving time series; and
d) storing said groups of time series.

21. The grouping method of claim 20 further comprising the steps of:
a) finding similarities for a particular time series during a partial period of said pre-defined time range;
b) applying a decision tree classification algorithm on each time slice, wherein each time slice is represented as a decision tree data structure; and
c) for each decision tree data structure associated with a time slice at said partial time range performing the following steps:
i. finding said nodes that contain said particular time series;
ii. for each node that contains said particular time series, finding other time series and increasing by one a counter value associated with each time series found; and
iii. sorting said time series in a descending order according to said total counter value, wherein the higher each of said counters is, the more similarly behaving said respective time series is, to said particular time series.

22. The method for grouping of claim 20, wherein said time series includes a set of time-dependent numbers that represent prices for financial instruments.

23. The method for grouping of claim 20, wherein each of said time series includes a set of derived time-dependent numbers that represent returns for financial instruments.
